(19) United States
(12) Patent Application Publication
(10) Pub. No.: US 2025/0273417 A1
(43) Pub. Date: Aug. 28, 2025

(54) CONTACTOR

(71) Applicant: Schneider Electric Industries SAS, Rueil-Malmaison (FR)

(72) Inventors: Shaofan Li, Shanghai (CN); Zhiping Huan, Shanghai (CN); Xu Han, Shanghai (CN); Lingjie Cheng, Shanghai (CN); Yuanzhong Wang, Shanghai (CN)

(73) Assignee: Schneider Electric Industries SAS, Rueil-Malmaison (FR)

(21) Appl. No.: 19/036,271

(22) Filed: Jan. 24, 2025

(30) Foreign Application Priority Data
Feb. 23, 2024 (CN) 2024203427718

(51) Int. Cl. H01H 50/02; H02G 3/08

(52) U.S. Cl. CPC H01H 50/02; H02G 3/081

(57) ABSTRACT

A contactor is proposed, which includes a stationary contact bracket having a main body and a plurality of terminals extending from the main body and configured to be electrically connected with wires, each of the plurality of terminals including a plate-shaped terminal body and a terminal hole penetrating through the terminal body; a junction box having a plurality of wiring holes and assembled to the stationary contact bracket, wherein each of the plurality of terminals is located in a corresponding wiring hole; wherein the surface of the junction box away from the stationary contact bracket is provided with a groove, and the groove is located between the plurality of terminals.

### TECHNICAL FIELD

The application relates to a contactor, in particular to a contactor with more reliable and safer operation.

### BACKGROUND

Contactors can be formed by assembling the junction box to the stationary contact bracket, and the terminals in the stationary contact bracket can be electrically connected with external circuits through the wiring holes in the junction box.

However, in the existing contactors, the stationary contact bracket cannot be compatible with different types of junction boxes, for example, the stationary contact bracket can only be assembled with the EverLink junction box, but not with other types of junction boxes such as NutHolder, which reduces the flexibility of contactor assembly. Moreover, in the existing contactors, because the contactors can't be equipped with phase partitions or protective covers, there is a risk of accidental short circuit between multiple terminals, and there is a risk that foreign objects (such as dust or fingers of operators) accidentally enter the wiring holes, which has a negative impact on the reliability and safety of the contactors.

Therefore, it is expected to propose a contactor to improve the shortcomings in the above-mentioned prior art.

### SUMMARY

According to the first aspect of the application, a contactor is proposed, which includes a stationary contact bracket having a main body and a plurality of terminals extending from the main body and configured to be electrically connected with wires, each of the plurality of terminals including a plate-shaped terminal body and a terminal hole penetrating through the terminal body; a junction box having a plurality of wiring holes and assembled to the stationary contact bracket, wherein each of the plurality of terminals is located in a corresponding wiring hole; wherein the surface of the junction box away from the stationary contact bracket is provided with a groove, and the groove is located between the plurality of terminals.

According to this scheme, corresponding equipment can be inserted into the groove of the junction box to improve the reliability and safety of the contactor.

In some aspects, the contactor may further include an phase partition, wherein the phase partition has a plate-shaped partition body and a partition protrusion protruding from the partition body, and the partition protrusion is engaged with and inserted into the groove.

According to this scheme, the phase partition can avoid accidental short circuit between multiple terminals, thus improving the reliability of the contactor.

In some aspects, the contactor may further include a protective cover having a top plate and a plurality of barrier walls extending from the top plate, wherein the barrier walls have cover protrusions protruding from the barrier walls, and the cover protrusions are engaged with and inserted into the grooves.

According to this scheme, the protective cover can prevent foreign objects (such as dust or operator's fingers) from accidentally entering the wiring hole, thus improving the safety of the contactor.

In some aspects, the protective cover can meet the protection level of IP20.

In some aspects, the main body may be provided with at least one installation feature, and the junction box is provided with at least one cooperative installation feature, and the installation feature cooperates with the cooperative installation feature to assemble the junction box to the stationary contact bracket.

In some aspects, the installation feature may be a recess, and the cooperative installation feature is a protrusion, and the protrusion is inserted into the recess.

In some aspects, the stationary contact bracket may further include a baffle extending from the main body and disposed between the plurality of terminal blocks to prevent short circuit between the plurality of terminal blocks.

In some aspects, the surface of the junction box adjacent to the stationary contact bracket can be provided with an avoidance hole, and the baffle extends into the avoidance hole.

In some aspects, the contactor may have three terminals and the junction box has three wiring holes.

In some aspects, the wires may be copper bars.

### BRIEF DESCRIPTION OF DRAWINGS

FIG. 1 shows a schematic diagram of a stationary contact bracket according to an embodiment of the application;

FIG. 2A shows a schematic diagram of a first junction box according to an embodiment of the application;

FIG. 2B shows a schematic diagram of the second junction box according to the embodiment of the application;

FIG. 2C shows a schematic diagram of the third junction box according to the embodiment of the application;

FIG. 3A shows a schematic diagram of the junction box of FIG. 2A assembled to the stationary contact bracket of FIG. 1;

FIG. 3B shows a schematic diagram of the junction box of FIG. 2B assembled to the stationary contact bracket of FIG. 1;

FIG. 3C shows a schematic diagram of the junction box of FIG. 2C assembled to the stationary contact bracket of FIG. 1;

FIG. 4 shows a schematic diagram of the phase partition according to the embodiment of the application;

FIG. 5A shows a schematic view of assembling the phase partition of FIG. 4 to the contactor of FIG. 3A;

FIG. 5B shows a schematic view of assembling the phase partition of FIG. 4 to the contactor of FIG. 3B;

FIG. 5C shows a schematic view of assembling the phase partition of FIG. 4 to the contactor of FIG. 3C;

FIG. 6 shows a schematic diagram of a protective cover according to an embodiment of the application;

FIG. 7A shows a schematic view of the protective cover of FIG. 6 assembled to the contactor of FIG. 3A;

FIG. 7B shows a schematic view of the protective cover of FIG. 6 assembled to the contactor of FIG. 3B;

FIG. 7C shows a schematic view of the protective cover of FIG. 6 assembled to the contactor of FIG. 3C.

### Reference Numeral

1 contactor
10 stationary contact bracket
12 main body
14 terminal
16 terminal body
18 terminal hole
20 recess
22 baffle
30 phase partition
32 partition body
34 partition protrusion
40 protective cover
42 top plate
44 barrier wall
46 cover protrusion
100 first junction box
110 wiring hole
120 groove
130 protrusion
140 avoidance hole
150 first crimping piece
200 second junction box
210 wiring hole
220 groove
230 protrusion
240 avoidance hole
250 second crimping piece
300 third junction box
310 wiring hole
320 groove
330 protrusion
340 avoidance hole
350 bolt

### DETAILED DESCRIPTION

In order to make the purpose, scheme and advantages of the technical scheme of the application more clear, the technical scheme of the embodiment of the application will be described clearly and completely with the attached drawings of the specific embodiment of the application. Unless otherwise specified, the terms used herein have the ordinary meaning in the art. Like reference numerals in the drawings represent like parts.

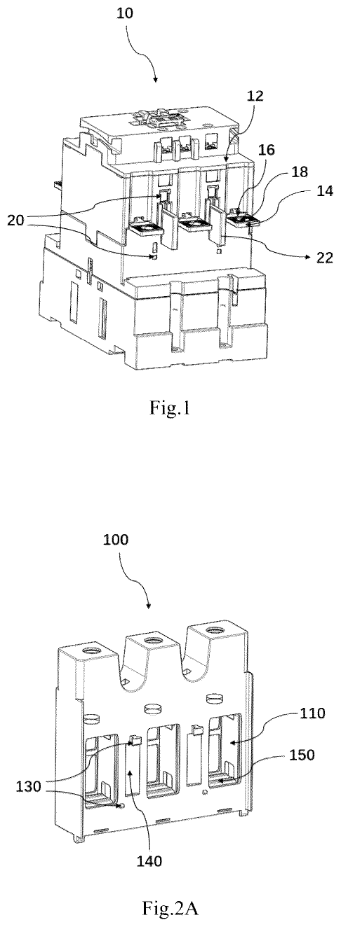

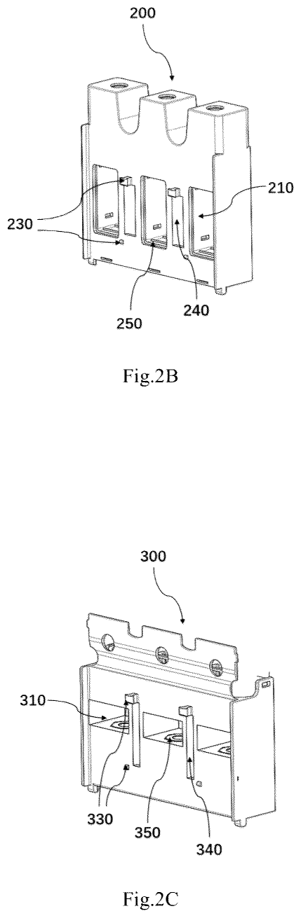

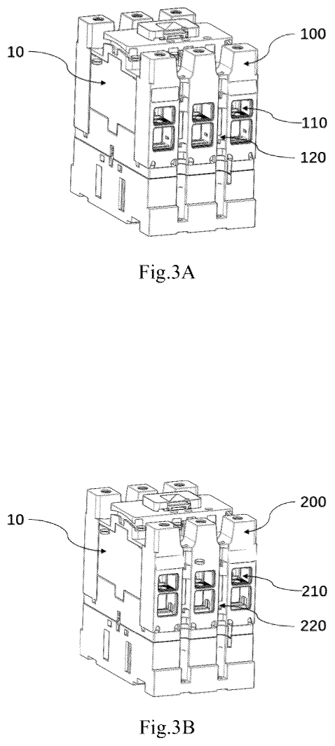

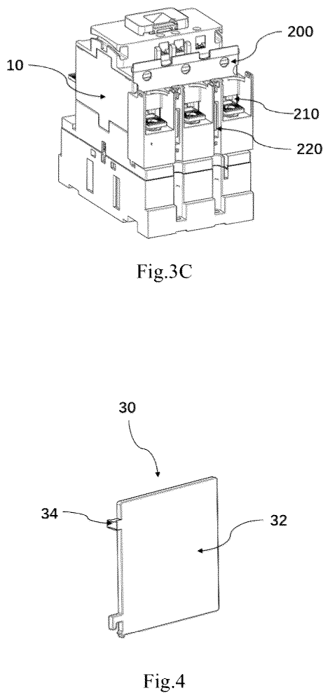

As shown in FIG. 3A, the contactor 1 includes a stationary contact bracket 10 and a first junction box 100, and the first junction box 100 is assembled to the stationary contact bracket 10. As shown in FIG. 1, the stationary contact bracket 10 has a main body 12, and a plurality of terminals 14 extending from the main body 12 and configured to be electrically connected with wires (e.g., copper bars). The terminals 14 include a plate-shaped terminal body 16 and a terminal hole 18 penetrating through the terminal body 16. As shown in FIG. 2A, the first junction box 100 has a plurality of wiring holes 110, and the terminals 14 are located in the corresponding wiring holes 110. The first junction box 100 may further include a first crimping piece 150 positioned below the terminal 14, and an actuating member, which can be driven by a user, thereby driving the first crimping piece 150 to move upward toward the terminal 14, thereby tightly crimping the wire with the terminal 2.

With the above-mentioned contactor 1, there is a risk of accidental short circuit between a plurality of terminals 14, and there is a risk that foreign objects (for example, dust or fingers of operators) accidentally enter the wiring holes 110, which has a negative impact on the reliability and safety of the contactor 1. Therefore, the surface of the first junction box 100 of the contactor 1, which is away from the stationary contact bracket 10, is provided with a groove 120, which is located between a plurality of terminals 14, and is used for assembling protective components for the contactor I to improve the reliability and safety of the contactor 1.

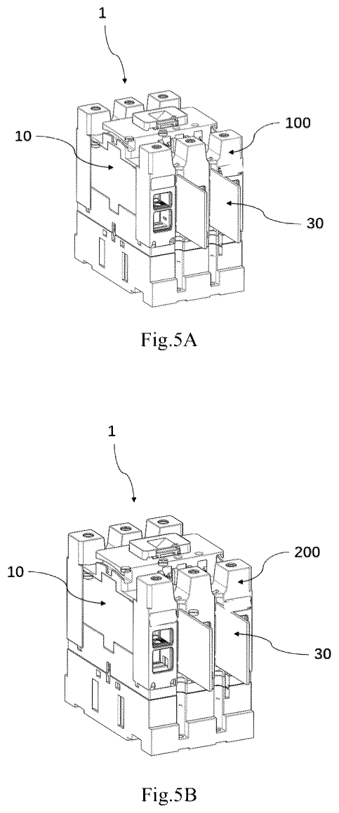

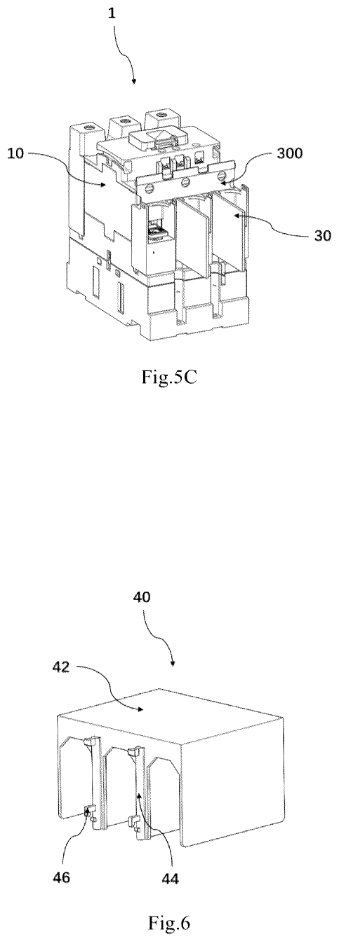

The protective member may be, for example, an phase partition 30, as shown in FIG. 4, which has a plate-shaped partition body 32 and a partition protrusion 34 protruding from the partition body 32. The partition protrusion 34 is engaged with and inserted into the groove 120 to assemble the phase partition 30 to the contactor 1 (as shown in FIG. 5A). In this way, the phase partition 30 can avoid accidental short circuit between a plurality of terminals 14, thereby improving the reliability of the contactor 1.

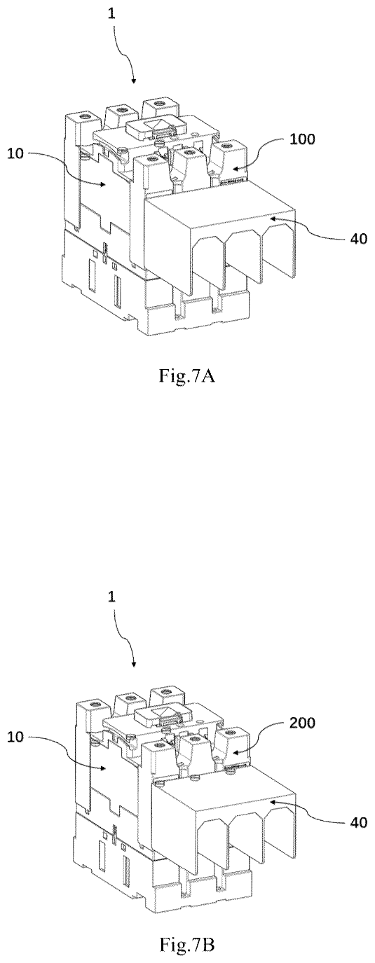

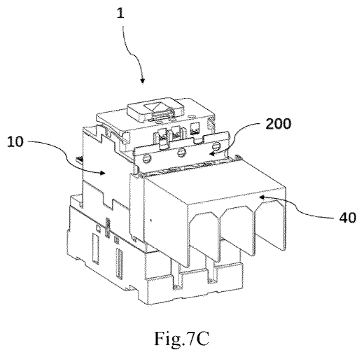

Alternatively, the protective member may be, for example, a protective cover 40. As shown in FIG. 6, the protective cover 40 has a top plate 42 and a plurality of barrier walls 44 extending from the top plate 42, and the barrier walls 44 have cover protrusions 46 protruding from the barrier walls 44, which are engaged with and inserted into the grooves 120 to assemble the protective cover 40 to the contactor 1 (as shown in FIG. 7A). In this way, the protective cover 40 can prevent foreign objects (for example, dust or operator's fingers) from accidentally entering the wiring hole 110, thereby improving the safety of the contactor 1. Preferably, the protective cover 40 can meet the protection level of IP20.

Preferably, the main body 12 may be provided with at least one installation feature, and the first junction box 100 is provided with at least one cooperative installation feature, which cooperates with the cooperative installation feature to assemble the first junction box 100 to the stationary contact bracket 10. For example, the installation feature may be a recess 20, and the cooperative installation feature may be a protrusion 130, which is inserted into the recess 20 to assemble the first junction box 100 to the stationary contact bracket 10. By providing installation features on the main body 12, the stationary contact bracket 10 can be assembled to different junction boxes (for example, the first junction box 100, the second junction box 200 and the third junction box 300), which improves the flexibility of assembling the contactor 1.

Preferably, the stationary contact bracket 10 may further include a baffle 22, which extends from the main body 12 and is disposed between the plurality of terminal blocks 14 to prevent short circuit between the plurality of terminal blocks 14. In addition, the surface of the first junction box 100 adjacent to the stationary contact bracket 10 may be provided with an avoidance hole 140, and the baffle 22 extends into the avoidance hole 140.

Alternatively, the contactor 1 may have three terminals 14 and the first junction box 100 has three wiring holes 110. It should be understood that the application does not intend to limit the number of terminal blocks 14 and corresponding wiring holes 110, and the contactor 1 can also have any other suitable number of terminal blocks and corresponding wiring holes.

In the above description, the contactor 1 is described by taking the first junction box 100 as an example. The contactor 1 of this application can be applied to different types of junction boxes, and examples of the second junction box 200 and the third junction box 300 will be described below. Since the examples of the second junction box 200 and the third junction box 300 are similar to those of the first junction box 100, only the differences between the examples of the second junction box 200 and the third junction box 300 and the example of the first junction box 100 will be described below for brevity.

As shown in FIG. 2B, compared with the first junction box 100, the second junction box 200 has an elastic compensation function, that is, when the connected wires have a loosening trend, this part of the loosening gap can be compensated. Specifically, the second crimping piece 250 of the second junction box 200 can be a deformable elastic piece. When wiring, the second crimping piece 250 is compressed to store energy, and when the connected wire has a loosening trend, the second crimping piece 250 releases energy and rebounds to continue to press the wire to the terminal 14.

As shown in FIG. 2C, the main difference between the third junction box 300 and the first junction box 100 is that instead of the first crimping piece 150, the third junction box 300 uses a bolt 350 and a nut to crimp the wire and the terminal 14.

In this paper, several exemplary embodiments of this application are described in detail with reference to preferred embodiments. However, those skilled in the art can understand that various variations and modifications can be made to the above specific embodiments without departing from the concept of this application, and various technical features and structures proposed by this application can be combined without exceeding the protection scope of this application, which is determined by the appended claims.

1. A contactor including:
a stationary contact bracket having a main body and a plurality of terminals extending from the main body and configured to be electrically connected with wires, each of the plurality of terminals including a plate-shaped terminal body and a terminal hole penetrating through the terminal body;
a junction box having a plurality of wiring holes and assembled to the stationary contact bracket, wherein each of the plurality of terminals is located in a corresponding wiring hole;
wherein the surface of the junction box away from the stationary contact bracket is provided with a groove, and the groove is located between the plurality of terminals.

2. The contactor according to claim 1, further including a phase partition, wherein the phase partition has a plate-shaped partition body and a partition protrusion protruding from the partition body, and the partition protrusion is engaged with and inserted into the groove.

3. The contactor according to claim 1, further including a protective cover having a top plate and a plurality of barrier walls extending from the top plate, wherein the barrier walls have cover protrusions protruding from the barrier walls, and the cover protrusions are engaged with and inserted into the grooves.

4. The contactor according to claim 3, wherein the protective cover meets the protection level of IP20.

5. The contactor according to claim 1, wherein the main body is provided with at least one installation feature, and the junction box is provided with at least one cooperative installation feature, and the installation feature cooperates with the cooperative installation feature to assemble the junction box to the stationary contact bracket.

6. The contactor according to claim 5, wherein the installation feature is a recess, and the cooperative installation feature is a protrusion, and the protrusion is inserted into the recess.

7. The contactor according to claim 1, wherein the stationary contact bracket further includes a baffle, which extends from the main body and is arranged between the plurality of terminals to prevent short circuit between the plurality of terminals.

8. The contactor according to claim 7, wherein the surface of the junction box adjacent to the stationary contact bracket is provided with an avoidance hole, and the baffle extends into the avoidance hole.

9. The contactor according to claim 1, wherein the contactor has three terminals and the junction box has three wiring holes.

10. The contactor according to claim 1, wherein the wire is a copper bar.
